(19) United States
(12) Patent Application Publication
(10) Pub. No.: US 2026/0238971 A1
(43) Pub. Date: Aug. 13, 2026

(54) AN APPARATUS AND A METHOD FOR SIMULTANEOUSLY OPERATING A PLURALITY OF VEHICLES

(71) Applicant: OLA ELECTRIC MOBILITY LIMITED, Bangalore (IN)

(72) Inventors: Bharathraj JAYARAMAN, Chennai (IN); Suvonil CHATTERJEE, Bengaluru (IN); Anusha S BASARI, Bangalore (IN)

(21) Appl. No.: 19/157,208

(22) PCT Filed: Feb. 15, 2024
(86) PCT No.: PCT/IN2024/050148

§ 371 Date: Aug. 15, 2025

(30) Foreign Application Priority Data
Feb. 16, 2023 (IN) 202341010317

(51) Int. Cl. H04W 4/46; B60W 10/22; B60W 10/30; B60W 50/08; B60W 50/14; G06F 3/16; G07C 5/02

(52) U.S. Cl. CPC H04W 4/46; B60W 10/22; B60W 10/30; B60W 50/082; B60W 50/14; G06F 3/162; G07C 5/02; B60W 2556/65; B60W 2710/22; B60W 2710/30

(57) ABSTRACT

An apparatus installed in a first vehicle for simultaneously operating a plurality of vehicles is provided. The apparatus comprising a controller (304) and a communication interface configured to establish a communication of the apparatus with a plurality of vehicles. The controller is configured to operate the first vehicle in a first mode or a second mode. In the first mode, the controller is configured to synchronize audio of each of the plurality of the vehicles with the first vehicle, where synchronization of the audio comprises enabling playing of the same audio in each of the first vehicle and the plurality of vehicles. In the second mode, in addition to the synchronization of the audio, the controller synchronizes operations of one or more sub-systems of the first vehicle and each of the plurality of vehicles with the synchronized audio.

### FIELD OF INVENTION

Embodiments of the present invention generally relates to vehicle to vehicle communication and more particularly relates to simultaneous operation of a plurality of vehicles based on short-range communication techniques.

### BACKGROUND OF THE INVENTION

During road trips when a number of people are travelling in a plurality of vehicles in groups, people generally prefer connecting to music in their vehicles. People inside their respective vehicle can connect their respective mobile phones and listen to music of their choice. However, the conventional art does not provide ways with which the people traveling in groups in each of the plurality of vehicle want to listen to same music.

Also, the group of people may want to use their vehicles for entertainment purposes. For example, the group of people may want to enjoy vehicles move on beat of music. However, the conventional art does not provide ways to synchronize movements between the plurality of vehicles.

### SUMMARY OF THE INVENTION

The following presents a simplified summary of the subject matter in order to provide a basic understanding of some of the aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

In one embodiment, the present subject matter discloses an apparatus installed in a first vehicle for simultaneously operating a plurality of vehicles. The apparatus comprising a controller, a memory coupled to the controller, and a communication interface configured to establish a communication of the apparatus with a plurality of vehicles. The controller is configured to operate the first vehicle in a first mode or a second mode. In the first mode, the controller is configured to synchronize audio of each of the plurality of the vehicles with the first vehicle, wherein synchronization of the audio comprises enabling playing of the same audio in each of the first vehicle and the plurality of vehicles. In the second mode, the controller is configured to synchronize audio of each of the plurality of the vehicles with the first vehicle, wherein synchronization of the audio comprises enabling playing of the same audio in each of the first vehicle and the plurality of vehicles, and synchronize operations of one or more sub-systems of the first vehicle and each of the plurality of vehicles with the synchronized audio.

In another embodiment, the present subject matter discloses a method for simultaneously operating a plurality of vehicles. The method comprises establishing, by a communication interface, a communication of the first vehicle with a plurality of vehicles and operating, by a controller, the first vehicle in a first mode or a second mode. In the first mode, the method comprises synchronizing audio of each of the plurality of the vehicles with the first vehicle, wherein synchronization of the audio comprises enabling playing of the same audio in the first vehicle and the plurality of vehicles. In the second mode, the method comprises synchronizing audio of each of the plurality of the vehicles with the first vehicle, wherein synchronization of the audio comprises enabling playing of the same audio in each of the first vehicle and the plurality of vehicles and synchronizing operations of one or more sub-systems of the first vehicle and each of the plurality of vehicles with the synchronized audio.

### BRIEF DESCRIPTION OF THE ACCOMPANYING DRAWINGS

The following drawings are illustrative of particular examples for enabling systems and methods of the present disclosure, are descriptive of some of the methods and mechanism, and are not intended to limit the scope of the invention. The drawings are not to scale (unless so stated) and are intended for use in conjunction with the explanations in the following detailed description.

FIG. 1 illustrates an environment for vehicle to vehicle communication between a plurality of four-wheeler vehicles, in accordance with one embodiment of the present invention.

FIG. 2 illustrates an environment for vehicle to vehicle communication between a plurality of two-wheeler vehicles, in accordance with one embodiment of the present invention.

FIG. 3 illustrates a block diagram of an apparatus installed in a vehicle, in accordance with one embodiment of the present invention.

FIG. 4 illustrates an example embodiment showing movement of plurality of sub-systems in a four-wheeler vehicle, in accordance with one embodiment of the present invention.

FIG. 5 illustrates an exemplary embodiment showing plurality of sub-systems in a two-wheeler vehicle, in accordance with one embodiment of the present invention.

FIG. 6 illustrates a method of operating a system installed in a vehicle, in accordance with one embodiment of the present invention.

Persons skilled in the art will appreciate that elements in the figures are illustrated for simplicity and clarity and may represent both hardware and software components of the system. Further, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

Exemplary embodiments now will be described. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

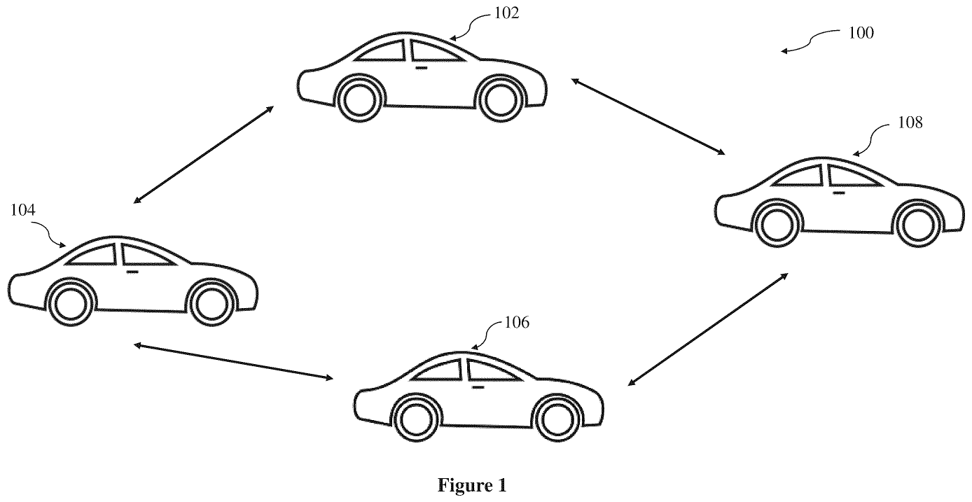

FIG. 1 illustrates an environment 100 showing vehicle to vehicle communication between a plurality of four-wheeler vehicles 102, 104, 106 and 108, in accordance with one embodiment of the present invention. Although only four vehicles are shown here, there can be any number of vehicles in the environment 100. The plurality of vehicles 102-108 are connected together via a short-range communication techniques. In one embodiment, the short-range communication techniques may include a Bluetooth communication. Each of the plurality of vehicles 102-108 communicate with each other to transfer content between them.

In one embodiment, the plurality of vehicles 102-108 may be connected via other wireless communication techniques, such as a WLAN, For example, communication between the plurality of vehicles 102-108 may be established via a cloud network (not shown). For this, each of the plurality of vehicles 102-108 may send a communication to the cloud network for connecting with the other vehicle in the plurality of vehicles 102-108.

In one embodiment, one vehicle may be a master vehicle while the other vehicles may be slave vehicles. For example, the vehicle 102 may be a master vehicle while vehicles 104, 106 and 108 may be slave vehicles. The master vehicle 102 may be responsible for establishing a communication with the vehicles 104, 106 and 108. For example, the master vehicle 102 may trigger a short-range communication with the plurality of vehicles 104, 106 and 108 when the plurality of vehicles 104, 106 and 108 come in a predefined range of the vehicle 102. The predefined range may include a distance of up to 30 feet (10 meters), however, it is not limited to the one defined here. In this application, the master vehicle 102 has been referred to as a first vehicle and the slave vehicles 104-108 have been referred to as the plurality of vehicles.

Each of the first vehicle and the plurality of vehicles 102-108 synchronizes audio and physical movement of one or more sub-systems. For example, each of the first vehicle and the plurality of vehicles, when connected, are synchronized together to stream same audio. Further, physical movement of one or more sub-systems in each of the plurality of vehicles 102-108 are synchronized. The synchronization of the physical movement of the one or more sub-systems allows movement of one or more parts present in the vehicles 102-108 with the synchronized music. Thus, with the synchronized music and movement of the parts of the vehicle, it may appear to someone present outside the vehicle as if the vehicles 102-108 are dancing together on the beat of the music.

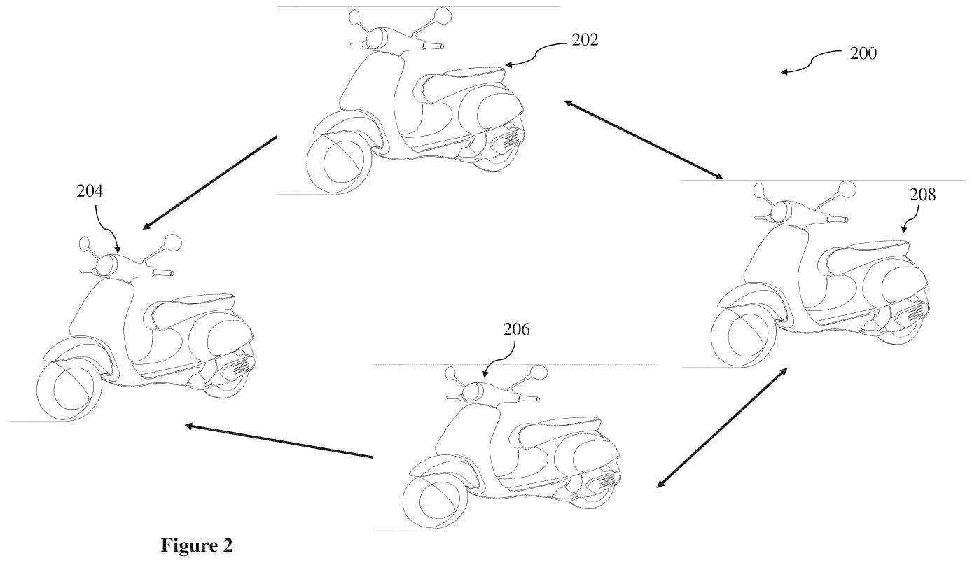

Referring to FIG. 2 now, an environment 200 illustrating a plurality of two-wheeler vehicles 202-208 are shown. Similar to FIG. 1, each of the plurality of two-wheeler vehicles 202-208 connect with each other and transmit content between each other. In one embodiment, the each of the plurality of vehicles 202-208 communicate via a short-range communication, such as Bluetooth communication. The rest of the description for the two-wheeler vehicles remain same as that explained above for four-wheeler vehicles in FIG. 1 and hence has been omitted here for the sake of redundancy. In one embodiment, the techniques of the present invention may also be applied to a three-wheeler vehicle. In another embodiment, the techniques of the present invention may also be applied to a five/six wheeler vehicle, for example, a truck.

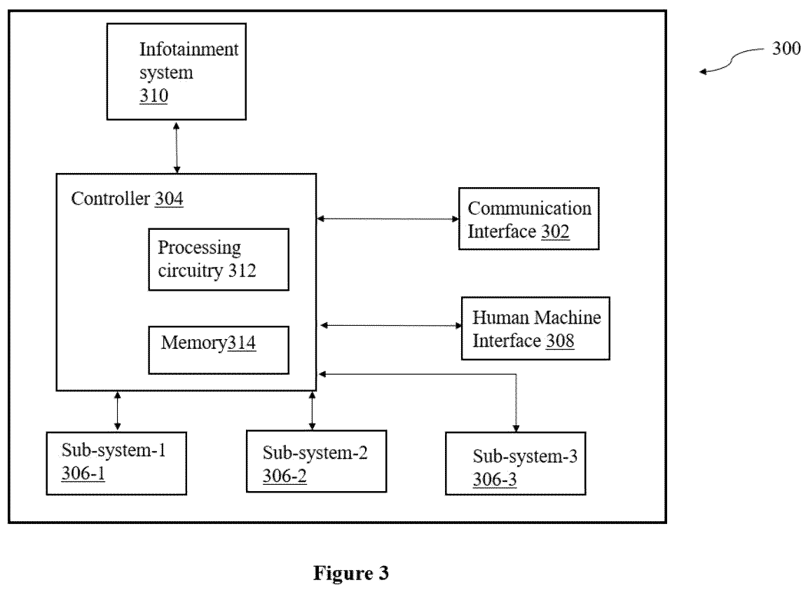

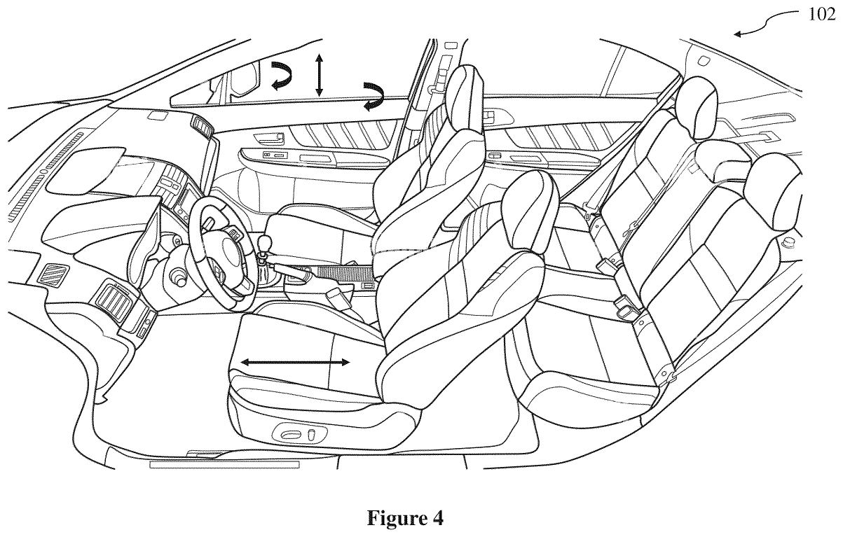

Referring to FIG. 3 now, a block diagram of an apparatus 300 installed in a vehicle is shown. The apparatus 300 may be responsible for synchronizing audio and physical movement of one or more sub-systems present in the vehicle. In one embodiment, the apparatus 300 is placed in the first vehicle 102 (or vehicle 202). In another embodiment, the apparatus 300 is placed in the first vehicle 102 (or vehicle 202) and the plurality of vehicles 104-108 (or 204-208).

The apparatus 300 comprises a communication interface 302, a controller 304, a plurality of sub-systems 306-1, 306-2, 306-3 (collectively called 306), a human machine interface (HMI) 308 and an infotainment system 310. Although only 3 sub-systems are shown, there may be any number of sub-systems present in the vehicle. Further, the controller 304 comprises a processing circuit 312 and a memory 314. The apparatus 300 may be powered by a power source present in the vehicle. In one embodiment, the power source may be battery source already present in the vehicle 102 (or vehicle 202). In another embodiment, the power source may be an independent low voltage power source.

When the apparatus 300 is installed in the first vehicle 102 (or vehicle 202), the apparatus 300 controls the operation of the each of the plurality of vehicles connected with the first vehicle 102 or the vehicle 202. In other words, a master vehicle 102, or 202 is configured to control the operation of each of the plurality if vehicles. In one embodiment, for a four-wheeler vehicle, the apparatus 300 may be installed in the boot space of the vehicle 102 while for the two-wheeler vehicle, the apparatus 300 may be placed somewhere below the seat. The apparatus may be operated at a predetermined speed. The predetermined speed may be selected such that there is a low voltage operation inside the vehicle.

The communication interface 302 is configured to establish a communication of the apparatus 300 with the plurality of vehicles. For example, the vehicle 102 may act like a master vehicle and may trigger a signal to the plurality of vehicles. The signal is triggered to establish a communication between the vehicle 102 (or vehicle 202) and the plurality of vehicles 104-108 (or vehicles 204-208). The vehicle 102 may enter a listen mode to detect the plurality of vehicles near to the vehicle 102. In other words, when the plurality of vehicles enters in the predefined range, the vehicle 102 may send a connection request to establish a short-range communication with the plurality of vehicles. The connection may then be established when each of the plurality of vehicles accepts the connection request from the first vehicle 102. In one embodiment, the communication interface 302 is a Bluetooth controller.

In one embodiment, the Bluetooth controller may use Bluetooth low energy 5.0 (BLE 5.0). The BLE 5.0 technology helps establish a connection of between master vehicle and a plurality of slave vehicles. The master vehicle is the one which is responsible for transmitting BLE packets to one or more receiving slave vehicles. The BLE packets are exchanged between the master vehicle and the slave vehicles periodically.

In one embodiment, a four-wheeler vehicle (e.g., vehicles 102-108) may be connected with a two-wheeler vehicle (i.e., vehicles 202-208). For example, a communication may be established between the four-wheeler vehicle and the two-wheeler vehicle. In this case, the synchronization may be performed between the one or more sub-systems and the audio present in the four-wheeler vehicle and the one or more sub-systems and the audio of the two-wheeler vehicle. In other words, same audio can be streamed in the four-wheeler vehicle and in the two-wheeler vehicle. Similarly, with the same audio being streamed, the operations of the sub-systems in the four-wheeler vehicles can be synchronized with the operations of the sub-systems in the two-wheeler vehicles.

The controller 304 is coupled to the communication interface 302 and is configured to control the communication interface 302. The memory 314 may store instructions which when executed by the processing circuitry 312 performs the operation of the controller 304. The processing circuitry 312 may include suitable logic, circuitry, components, interface, and/or code, executable by the components to carry out one or more operations of the vehicle 102 (or the vehicle 202).

The controller 304 operates the vehicle 102 (or 202) in a first mode or in a second mode. In one embodiment, the first mode is a drive mode where the vehicle 102 (or 202) is moving on a road whereas the second mode is a mode where the vehicle is stationary at one place. The vehicles may be stationary at places such as parking lot, places designated for entertainment (e.g., entertainment parks), gardens, house, etc. The first mode or the second mode may be recognized using one or more ways. For example, the first mode is recognized when ignition of the vehicle 102, 202 is in ON stage. Further, the second mode is recognized when ignition of the vehicle 102, 202 is in OFF stage. However, there may be more ways of recognizing whether the vehicle is in the first mode or the second mode and is not limited to the one mentioned here.

In one embodiment, the controller 304 (being part of the master vehicle 102 or 202) is configured to transmit a signal to the plurality of slave vehicles. The signal may trigger the synchronization between the master vehicle and the plurality of slave vehicles. As soon as the signal is transmitted by the master vehicle 102 or 202, the master vehicle 102 or 202 establishes a connection to control the controllers present in the plurality of slave vehicles. Thus, the controllers present in each of the plurality of slave vehicles, in addition to, controlling the audio and the physical movement of the one or more sub-systems and also gets controlled by the controller 304 present in the master vehicle 102, or 202.

The plurality of sub-systems 306 may be coupled to the controller 304. Each of the plurality of sub-systems 306 are operated by the controller 304 in different ways. In one embodiment, the plurality of sub-systems 306 may be different for four-wheeler vehicle and two-wheeler vehicle. Some of the examples of the sub-systems in the four-wheeler vehicle are, but not limited to, window mechanism sub-system, seating mechanism sub-system, door movement sub-system, sub-roof operation sub-system, suspension sub-system, side mirror movement sub-system.

Each of the sub-systems may include motor mechanism to move different parts of the vehicle. The movement of the vehicle appears to the users standing outside the vehicle as if the vehicle is dancing in sync with the music. For example, the window glasses will raise up and down, the front mirrors will be opened and closed, the doors can be operated, the front seats will move backward and forward, the sunroof will operate by opening and closing. The car vibrates and makes the system dance. As this is integrated with the music, the system is in sync with the music and all the paired vehicles will make the same moves.

The controller 304 is configured to control each of the sub-systems 306 present in the vehicle, In particular, the controller 304 is configured to control motors present in each of the mechanisms present in the vehicle. For example, the controller 304 is configured to control motor present in the seating mechanism to move the seats in a forward and backward direction. Similarly, the controller 304 is configured to control the motor mechanism present in the side mirrors of the vehicle so as to move the side mirrors in inward and outward direction.

Further, some of the examples of the sub-systems in the two-wheeler vehicle are, but not limited to, suspension sub-system, handlebar sub-system, seating mechanism sub-system, foot pegs and foot board mechanism sub-systems, side stand mechanism sub-system, vehicle movement sub-system. In particular, in a two-wheeler vehicle, the suspension jumps or moves, the handlebar of the two-wheeler vehicle will be operated to move, the seat is operated to move backward and forward, the foot pegs and foot board will also be operated in sync with the music. The vehicle can move backwards, forward and move sideways. The motor that is placed in the boot space balances the vehicle action. All the paired vehicles will make the same moves.

In one embodiment, sliding trails may be provided at the bottom of the seats present in the vehicles (102-108 or 202-208). A motor may be connected with the sliding trails for moving the seats in the forward and the backward direction. The motor may be controlled by the controller 304. Similarly, hydraulic shockers may be controlled by the controller 304. Hydraulic shockers may be responsible for controlling the suspension present in the vehicles.

Similarly, stepper motor may be provided in the handlebars and the side mirrors of the vehicles. The stepper motor may be controlled by the controller 304. The stepper motor may move the handlebars and the side mirrors by a fixed number of degrees. Similarly, a DC motor or a stepper motor may be provided for controlling side stand(s) in a two-wheeler vehicle. The DC motor or the stepper motor may be controlled by the controller 304. Each of the sliding trails, hydraulic shockers, stepper motor and DC motor are operational when the vehicle is operated in the second mode.

In one embodiment, the controller 304, in addition to controlling the sub-systems 306-1, 306-2, and 306-3, also synchronizes with other vehicles so that the sub-systems of all the vehicles move together. For example, when the plurality of vehicles are connected with each other, the apparatus 300 present in each of the vehicle synchronizes together using techniques as mentioned above. Each of the plurality of vehicles may synchronize when they are in same mode. For example, the physical movement of the one or more sub-systems 306 synchronizes only when the plurality of vehicles are in the second mode.

In the second mode, the controller 304 in the master vehicle may transmit asynchronous signals to the plurality of slave vehicles. The asynchronous signals include audio commands, and movement commands to synchronize movement of sub-systems between the master vehicle and plurality of slave vehicles. With the transmission of the audio signals, same audio can be played in the master vehicles and each of the slave vehicles (as explained above). Further, with the transmission of the movement commands, movement of the sub-systems in the master vehicle and each of the slave vehicles can be synchronized.

In one embodiment, the controller 304 can use a mixed signal transmission. In other words, one or more protocols can be used to transmit the asynchronous signals to the plurality of slave vehicles. In one embodiment, radio frequency (RF) based serial communication can be used to transmit the asynchronous signals from the master vehicle and plurality of slave vehicles.

In one embodiment, the controller 304 is coupled to the infotainment system 310. The infotainment system 310 may include suitable logic, circuitry, components, interface, and/or code, executable by the components to output at least one of audio content, video content, or the like. The infotainment system 310 may be configured to output audio content. In an embodiment, the infotainment system 310 may output the audio content based on a control signal received from the vehicle 102. In another embodiment, the infotainment system 310 may output the audio content based on a user input from the user of the vehicle 102. Examples of the infotainment system 310 may include, but not limited to, an entertainment 20 system, a navigation system, a vehicle user interface (UI) system, a human machine interface system, an Internet-enabled communication system, a music system, and the like.

The infotainment system 310 may be present in each of the plurality of vehicles 102-108 (or vehicles 202-208) and may be controlled by controller 304 placed in each vehicle. The audio in the plurality of vehicles can be streamed via the infotainment system 310 present in each vehicle. Further, one or more speakers may be provided in each of the plurality of vehicles via which audio can be streamed in each of the plurality of vehicles. When an audio is streamed in the master vehicle 102 (or 202) by users present in the master vehicle 102, the slave vehicles acts as speakers such that same audio as that of the master vehicle is streamed in each of the slave vehicle. The controller 304 may also control color display or animated images on the infotainment system 310 or on the HMI screen with the synchronized audio.

The controller 304 in addition to controlling the sub-systems and the audio in the vehicles also synchronizes with the controller in each of the plurality of the vehicles such that the movement and audio of the each of the plurality of vehicles 104, 106 and 108 (or 204, 206 and 208) can be synchronized with the movement and audio of the vehicle 102 (or vehicle 202). The synchronization can happen when the vehicles 102-108 (or vehicles 202-208) are connected together using short-range communication techniques (such as Bluetooth). With synchronized sub-systems and audio, it appears as if all the vehicles are dancing together on the beat of the music.

As explained above, the controller 304 operates the vehicles in either the first mode or in the second mode. In the first mode, the Controller 304 operates the infotainment 310 of the vehicle 102 (or vehicle 202) such that the audio in each of the vehicle is synchronized. In other words, same audio is streamed in each of the plurality of vehicles as is streamed in the vehicle 102 (or vehicle 202). For this, the Controller 304 may communicate with controllers placed in other vehicles and synchronize with them.

In the second mode, in addition to the synchronization of the audio, the controller 304 is also configured to synchronize operations of the one or more sub-systems of the vehicle 102 (or vehicle 202) with the vehicles 104-108 (or vehicles 202-208). Thus, in the second mode, the each of the plurality of vehicles streamed the same audio and moves in synchronization with each other. For example, in the second mode, when the audio starts streamed in each of the plurality of vehicles, the windows of the vehicles may start to open and close, the seats of the vehicles may start moving in forward and backward direction, the vehicles may start moving in upward and downward direction (with movement of the suspension), all at the same time. With this, it appears as if the vehicles are dancing at the beat of the audio being placed in the vehicles.

In one embodiment, the second mode may be activated automatically by the controller 304 as soon as the vehicle becomes stationary. In another embodiment, the second mode may be activated by user input via the HMI 308 or the infotainment 310. In yet another embodiment, the second mode is be activated when the controller 304 detects that the ignition of the vehicle is in OFF state. In one embodiment, the controller 304 is configured to switch the vehicle between the first mode and the second mode. The switching may happen automatically upon detection of the status of the ignition or upon detecting that the vehicle is in park mode or drive mode.

In one embodiment, the human machine interface (HMI) 308 is configured to render information to the user of the vehicle 102. The information may include name of the song being played in the vehicle 102, the duration of the song, source from where the song is being played (e.g., pen drive, FM/AM/CD, etc.), etc. The HMI 308 may also display a list of vehicles connected to the first vehicle 102 (or vehicle 202).

Referring to FIG. 4 now, an example embodiment 400 showing movement of plurality of the sub-systems 306 in a four-wheeler vehicle is disclosed. Direction of the arrows in the FIG. 4 signifies direction of movement of the sub-systems in the vehicle. For example, seats in the vehicle can move in the forward and the backward direction, side mirrors can fold and open, windows can open and close, doors can open and close. Although, only few sub-systems are shown, however, there may be more sub-systems which may move in synchronization with other sub-systems. Some examples of other sub-systems may include, but not limited to, suspension mechanism for movement of the suspension of the vehicle, vibration mechanism for facilitating vibration of the vehicle. In one embodiment, the suspension mechanism may move the vehicle in the upward and downward direction.

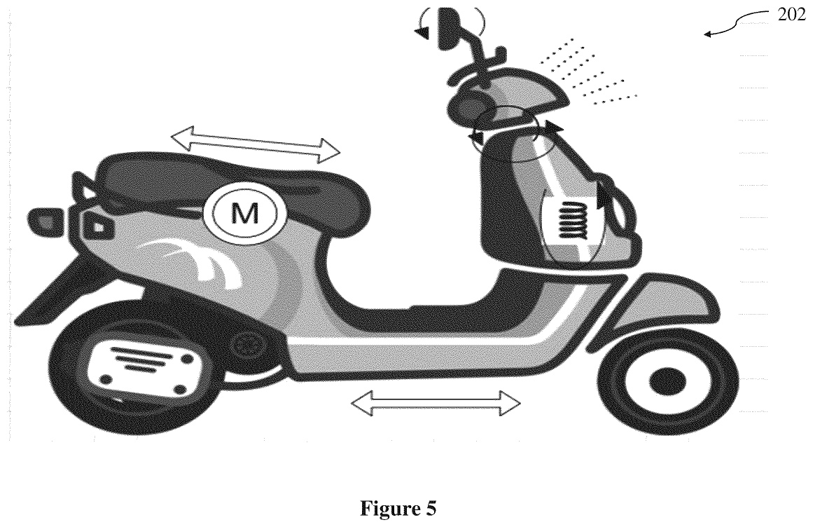

Referring to FIG. 5 now, an example embodiment 500 showing movement of plurality of the sub-systems 306 in a two-wheeler vehicle is disclosed. Direction of the arrows in the FIG. 5 signifies direction of movement of the sub-systems in the vehicle. For example, seats in the vehicle can move in the forward and the backward direction, side mirrors can fold and open or even rotate in a 360 degree direction, suspension of the vehicle can move the vehicle 202 in upward and downward direction.

In one embodiment, the vehicle 202 can itself move in forward and backward direction when the vehicle is placed on a side stand (not shown). In one embodiment, the side stand of the vehicle 202 may open and close. In one embodiment, the side stand of the vehicle may have a balancing sensor which may balance the vehicle 202 when the side stand is closed. Although, only few sub-systems are shown, however, there may be more sub-systems which may move in synchronization with other sub-systems. Some examples of other sub-systems may include, but not limited to, vibration mechanism for facilitating vibration of the vehicle. In one embodiment, the suspension mechanism may move the vehicle in the upward and downward direction.

In one embodiment, the sub-system 306 may also include drivers for controlling the lighting mechanism. The lighting mechanism may include headlamps and other light emitting sources present on the vehicles 102-108 (or 202-208). The controller 304 is coupled to the drivers to control the headlamps and other light emitting sources present on the vehicle 102 (or 202). The controller 304 synchronizes the headlamps and other light emitting sources of the vehicle 102 (or vehicle 202) and the headlamps and other light sources of the other plurality of vehicles with the synchronized audio. In other words, it appears to the person outside the vehicles as if the headlamps and other light emitting sources are blinking together with the synchronized audio.

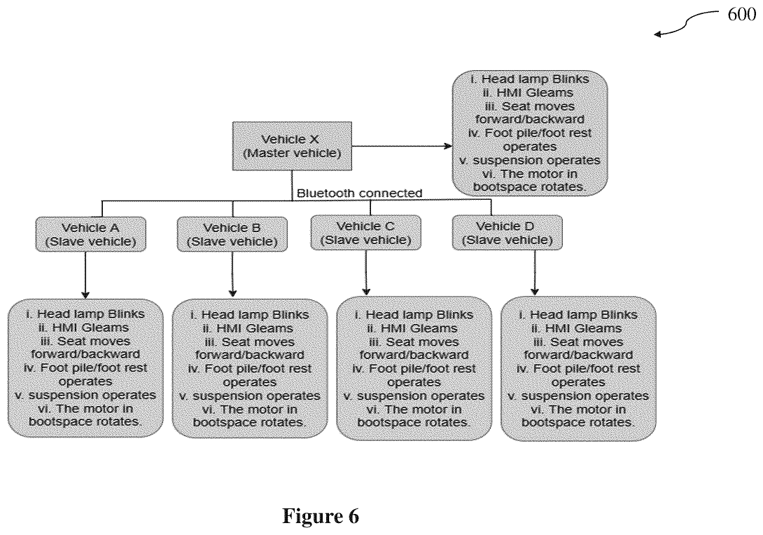

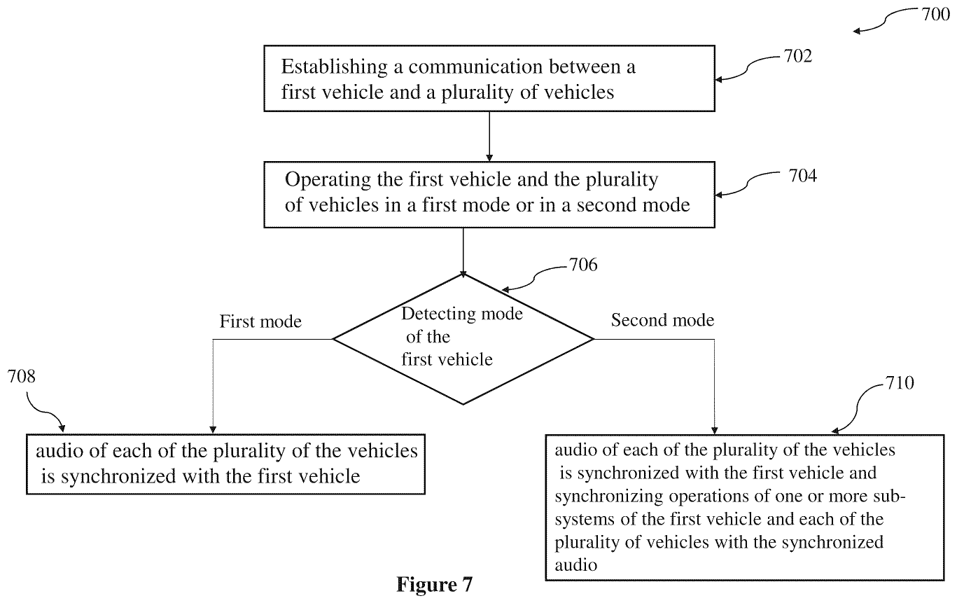

Referring to FIG. 6 now, a flowchart for showing simplified process of synchronizing sub-systems 306 and the audio among the plurality of vehicles. As shown in FIG. 6, the vehicle X acts as a master vehicle which is connected to slave vehicles A-D. As shown, the sub-systems in the master vehicle include blinking of head lamp, gleaning of HMI, forward and backward movement of seats, operation of foot pile/footrest, operation of suspension, rotation of motor present in the boot space of the vehicle. The same operations of the sub-systems are also performed in the slave vehicles A-D. The operations in the slave vehicles are performed in synchronization with the master vehicle. Further, in the first mode, the audio of the master vehicle and the slave vehicles are synchronized whereas in the second mode, the sub-systems of the master vehicle and the slave vehicles are synchronized with the synchronized audio.

Referring to FIG. 7 now, a flowchart of a method 700 for operating apparatus installed in a vehicle is disclosed. At block 702, the method comprises establishing a communication between a first vehicle and a plurality of vehicles. In other words, the first vehicle may be a master vehicle 102 (or vehicle 202) and the plurality of vehicles may be slave vehicles 104-108 (or vehicles 204-208). The first vehicle and the plurality of vehicles are connected together using short-range communication techniques. A communication interface connects the first vehicle and the plurality of vehicles.

At block 704, the method comprises operating the first vehicle and the plurality of vehicles in a first mode or in a second mode. The first mode is a mode where the first vehicle and the plurality of vehicles are moving, and the second mode is a mode where the first vehicle and the plurality of vehicles are in stationary. The operation of the first vehicle and the plurality of vehicles in the first mode or the second mode is controlled by a controller. The controller may be placed in a boot space of a vehicle.

At block 706, it is detected whether the first vehicle 102 (or vehicle 202) is operating in the first mode or in the second mode. If the first vehicle 102 (vehicle 202) is operating in the first mode, audio of each of the plurality of the vehicles is synchronized with the first vehicle, wherein synchronization of the audio comprises enabling playing of the same audio in the first vehicle and the plurality of vehicles.

However, if it is detected that the first vehicle 102 (or the vehicle 202) is operating in the second mode, audio of each of the plurality of the vehicles is synchronized with the first vehicle, wherein synchronization of the audio comprises enabling playing of the same audio in the first vehicle and the plurality of vehicles. In addition, in the second mode, operations of one or more sub-systems of the first vehicle and each of the plurality of vehicles are synchronized with the synchronized audio. In other words, in the second mode, it appears to the person outside the vehicle as if the vehicle is dancing with the same audio being played in each of the plurality of vehicles.

As will be appreciated by one of skilled in the art, the present disclosure may be embodied as a method and system. The present disclosure may take the form of a hardware embodiment implemented by a FPGA.

In the specification, there has been disclosed exemplary embodiments of the invention. Although specific terms are employed, they are used in a generic and descriptive sense only and not for purposes of limitation of the scope of the invention

1. An apparatus installed in a first vehicle for simultaneously operating a plurality of vehicles, the apparatus comprising:
a controller;
a memory coupled to the controller; and
a communication interface configured to establish a communication of the apparatus with a plurality of vehicles, wherein the controller is configured to:
operate the first vehicle in a first mode or a second mode, wherein:
in the first mode, the controller is configured to synchronize audio of each of the plurality of the vehicles with the first vehicle, wherein synchronization of the audio comprises enabling streaming of the same audio in each of the first vehicle and the plurality of vehicles, and
in the second mode, the controller is configured to:
synchronize audio of each of the plurality of the vehicles with the first vehicle, and
synchronize physical movement of one or more sub-systems of the first vehicle and each of the plurality of vehicles with the synchronized audio.

2. The apparatus as claimed in claim 1, wherein the first mode is a drive mode, and the second mode is a parking mode.

3. The apparatus as claimed in claim 2, wherein the drive mode is detected when ignition of the first vehicle is in ON state.

4. The apparatus as claimed in claim 2, wherein the parking mode is detected when ignition of the first vehicle is in OFF state.

5. The apparatus as claimed in claim 1, wherein the communication interface is a Bluetooth Controller.

6. The apparatus as claimed in claim 1, wherein the one or more sub-systems include seating mechanism, window opening and closing mechanism, sunroof mechanism, suspension mechanism, lighting mechanism.

7. The apparatus as claimed in claim 1, wherein the operations of the one or more sub-systems comprises a movement of a seat (backward and forward), a movement of the handlebar, a movement of a foot floor, an operation of a side stand (On/off).

8. The apparatus as claimed in claim 1, wherein first vehicle and the plurality of vehicles comprises at least one of a four-wheeler vehicle or a two-wheeler vehicle.

9. The apparatus as claimed in claim 1, wherein the first vehicle further comprises a human machine interface (HMI) configured to render information to a user of the first vehicle.

10. The apparatus as claimed in claim 1, wherein the controller is configured to switch the first vehicle from the first mode to the second mode, or vice versa.

11. A method for simultaneously operating a plurality of vehicles, the method comprising:
establishing, by a communication interface, a communication of the first vehicle with a plurality of vehicles;
operating, by a controller, the first vehicle in a first mode or a second mode, wherein:
in the first mode, synchronizing audio of each of the plurality of the vehicles with the first vehicle, wherein synchronization of the audio comprises enabling streaming of the same audio in the first vehicle and the plurality of vehicles, and in the second mode:
synchronizing audio of each of the plurality of the vehicles with the first vehicle, and
synchronizing physical movement of one or more sub-systems of the first vehicle and each of the plurality of vehicles with the synchronized audio.

12. The method as claimed in claim 11, wherein the first mode is a drive mode, and the second mode is a parking mode.

13. The method as claimed in claim 12, wherein the drive mode is detected when ignition of the first vehicle is in ON state.

14. The method as claimed in claim 12, wherein the parking mode is detected when ignition of the first vehicle is in OFF state.

15. The method as claimed in claim 11, wherein the communication interface is a Bluetooth Controller.

16. The method as claimed in claim 11, wherein the one or more sub-systems include seating mechanism, window opening and closing mechanism, sunroof mechanism, suspension mechanism, lighting mechanism.

17. The method as claimed in claim 11, wherein the operations of the one or more sub-systems comprises a movement of a seat (backward and forward), a movement of the handlebar, a movement of a foot floor, an operation of the side stand (On/off).

18. The method as claimed in claim 11, wherein the first vehicle and the plurality of vehicles comprises at least one of a four-wheeler vehicle or a two-wheeler vehicle.

19. The method as claimed in claim 11, wherein the first vehicle further comprises a human machine interface (HMI) configured to render information to a user of the first vehicle.

20. The method as claimed in claim 11, further comprising switching the first vehicle from the first mode to the second mode, or vice versa.
